(19) United States
(12) Patent Application Publication
(10) Pub. No.: US 2014/0132121 A1
(43) Pub. Date: May 15, 2014

(54) TRANSVERSE FLUX MOTOR

(71) Applicant: Johnson Electric S.A., Murten (CH)

(72) Inventors: Jinyun GAN, Hong Kong (CN); Chuiyou ZHOU, Hong Kong (CN); Wei ZHANG, Shenzhen (CN); Xiaomei YUAN, Shenzhen (CN)

(73) Assignee: Johnson Electric S.A., Murten (CH)

(21) Appl. No.: 14/080,065

(22) Filed: Nov. 14, 2013

(30) Foreign Application Priority Data
Nov. 14, 2012 (CN) 201210455540.X
Nov. 1, 2013 (CN) 201310535029.5

(51) Int. Cl. H02K 1/14; H02K 7/14; H02K 1/27

(52) U.S. Cl. CPC H02K 1/145; H02K 1/2786; H02K 7/14
USPC 310/67 A; 310/156.02

(57) ABSTRACT

A transverse flux electric motor (10) includes an inner stator (15) and an outer rotor (12). The rotor (12) comprises a plurality of permanent magnets (70) in an alternating arrangement with a plurality of flux concentration strips (50). The flux concentration strips (50) contain grooves (60) on a surface (58) remote from the stator (15). The stator (15) may comprise a plurality of stator units (80), each comprising a stator yoke (82) positioned between a pair of stator cores (84). The stator cores (84) are substantially gear shaped and comprise a plurality of stator teeth (92). The stator teeth (92) of different stator cores (84) are circumferentially offset from each other. The stator yoke (82) may comprise a coiled metal strip wrapped around a central shaft (72) of the motor (10).

### CROSS REFERENCE TO RELATED APPLICATION(S)

This application claims the benefit of Chinese patent application serial no. 201210455540.X, filed on Nov. 14, 2012, and Chinese patent application serial no. 201310535029.5, filed on Nov. 1, 2013. The entire content of the aforementioned patent applications are hereby incorporated by reference for all purposes.

### BACKGROUND

Transverse flux motors may be used in many different applications. For example, an electric bicycle may utilize a transverse flux motor having an outer rotor and an inner stator as a direct drive mechanism. In such applications, the stator typically comprises at least one stator unit, wherein each stator unit comprises a winding coil wrapped around a stator yoke, located between a pair of stator cores. Each stator core comprises a plurality of stator teeth, wherein stator teeth from different stator cores are circumferentially offset from each other.

The rotor typically comprises a plurality of stacked rotor laminations forming a rotor core and a plurality of permanent magnets. A rotor lamination comprises an outer ring and a plurality of circumferentially spaced protrusions extending inwards from the outer ring. Thus, the outer ring forms an outer wall of the rotor, while the protrusions function as flux concentration units, with the permanent magnets positioned between adjacent flux concentration units.

During operation, the magnetic flux generated by the permanent magnets is concentrated by the flux concentration units near the stator and enters the stator teeth on the surface of the stator cores. As a result, the portions of the flux concentration units near the outer ring, while adding extra weight, contribute little to the function of the motor. In addition, eddy currents in the stator yoke caused by the switching current in the winding coils can affect performance of the motor.

Accordingly, it would be advantageous to have a high efficiency and light weight transverse flux electric motor. In addition, it is desirable to have a transverse flux motor that generates little eddy current during operation.

### SUMMARY

Some embodiments are directed towards a lighter transverse flux electric motor that experiences a reduced amount of eddy current. In some embodiments, the motor comprises a rotor comprising a substantially annular ring with alternating permanent magnets and flux concentration strips. The flux concentration strips contain a groove on a surface remote from the stator.

The motor also comprises a stator comprising a plurality of stator units. Each stator unit may comprise a stator yoke located between two stator cores. In addition winding coils may be wrapped around the stator yoke. The stator cores may be substantially gear shaped, with a plurality of stator teeth. The stator teeth of different stator cores are configured to be circumferentially offset from each other. In some embodiments, the stator yoke is substantially cylindrical, and comprises a metal strip wound around a central shaft. In other embodiments, the stator core and/or stator yoke may be made from separate segments or pieces. The stator core and/or stator yoke may also comprise a plurality of through channels or holes.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates a transverse flux electric motor in accordance with some embodiments.

FIG. 2 illustrates an exploded view of a transverse flux electric motor in accordance with some embodiments.

FIG. 3 illustrates a fixed ring used in a transverse flux electric motor in accordance with some embodiments.

FIG. 4 illustrates a portion of a stator used in a transverse flux electric motor in accordance with some embodiments.

FIG. 5 illustrates a portion of a rotor used in a transverse flux electric motor in accordance with some embodiments.

FIG. 6 illustrates a rotor yoke used in a transverse flux electric motor in accordance with some embodiments.

FIG. 7 illustrates a transverse flux electric motor having a split stator in accordance with some embodiments.

FIG. 8 illustrates an alternate embodiment of a transverse flux electric motor.

FIG. 9 illustrates a transverse flux electric motor in accordance with some embodiments.

### DETAILED DESCRIPTION

Various features are described hereinafter with reference to the figures. It shall be noted that the figures are not drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

An aspect or an advantage described in conjunction with a particular embodiment is not necessarily limited to that embodiment and may be practiced in any other embodiments, even if not so illustrated, or if not explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

Some embodiments are directed towards a lighter transverse flux electric motor that experiences a reduced amount of eddy current. In some embodiments, the motor comprises a rotor comprising a substantially annular ring with alternating permanent magnets and flux concentration strips. The flux concentration strips contain a groove on a surface remote from the stator. The grooves reduce the weight of the motor, and may be used in some embodiments to align the stator within an outer shell.

The motor also comprises a stator comprising a plurality of stator units. Each stator unit may comprise a stator yoke located between two stator cores. In addition, winding coils may be wrapped around the stator yoke. The stator cores may be substantially gear shaped, with a plurality of stator teeth. The stator teeth of different stator cores may be configured to be circumferentially offset from each other. In some embodiments, the stator yoke is substantially cylindrical, and comprises a metal strip wound around a central shaft. In other embodiments, the stator core and/or stator yoke may be made from separate segments or pieces. The stator core and/or stator yoke may also comprise a plurality of through channels or holes.

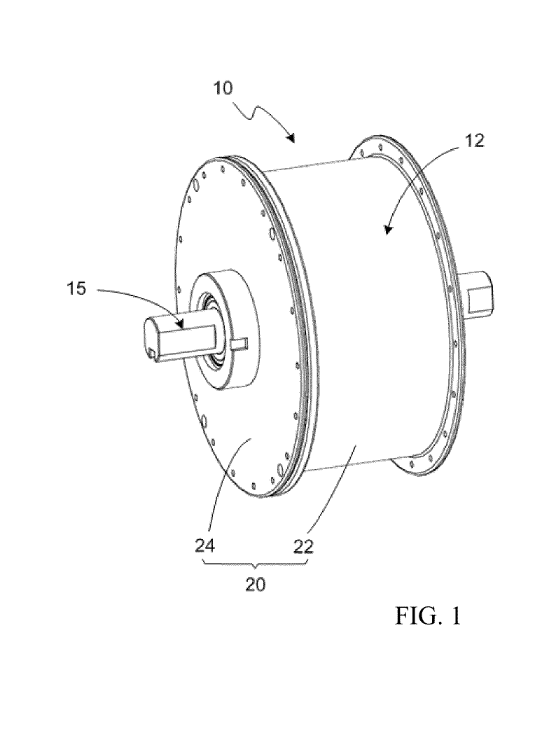

Transverse flux electrical motors in accordance with the embodiments may be used in a variety of different applications. For example, FIG. 1 illustrates a transverse flux electrical motor 10 that may be used in an electrical bicycle or scooter. In some embodiments, motor 10 may comprise a rotor 12 that encloses or surrounds a stator 15, wherein rotor 12 is configured to rotate around stator 15. For example, in some embodiments, stator 15 is fixed to a portion, e.g., the seat stay, of the frame of the electrical bicycle, while rotor 12 is fixed to the rear wheel of the bicycle, such that the bicycle wheel spins when rotor 12 spins around stator 15. In some embodiments, rotor 12 comprises an outer shell 20, which comprises a substantially cylindrical shell body 22 and an end cap 24. It shall be noted that the term “substantially” or “substantial” such as the “substantially cylindrical” is used herein to indicate that certain features, although designed or intended to be perfect (e.g., perfectly cylindrical), the fabrication or manufacturing tolerances, the slacks in various mating components or assemblies due to design tolerances or normal wear and tear, or any combinations thereof may nonetheless cause some deviations from this designed, perfect characteristic. Therefore, one of ordinary skill in the art will clearly understand that the term “substantially” or “substantial” is used here to incorporate at least such fabrication and manufacturing tolerances, the slacks in various mating components or assemblies, or any combinations thereof.

It will be understood that although, for the purposes of example, the application will refer to electrical motor 10 for an electrical bicycle, electrical motors in accordance with some embodiments may be used in many other applications involving the transfer of power to a rotary motion. It is also understood that while the illustrated embodiments depicts motor 10 having inner stator 15 and outer rotor 20, other configurations are also possible (e.g., an inner rotor, outer stator configuration).

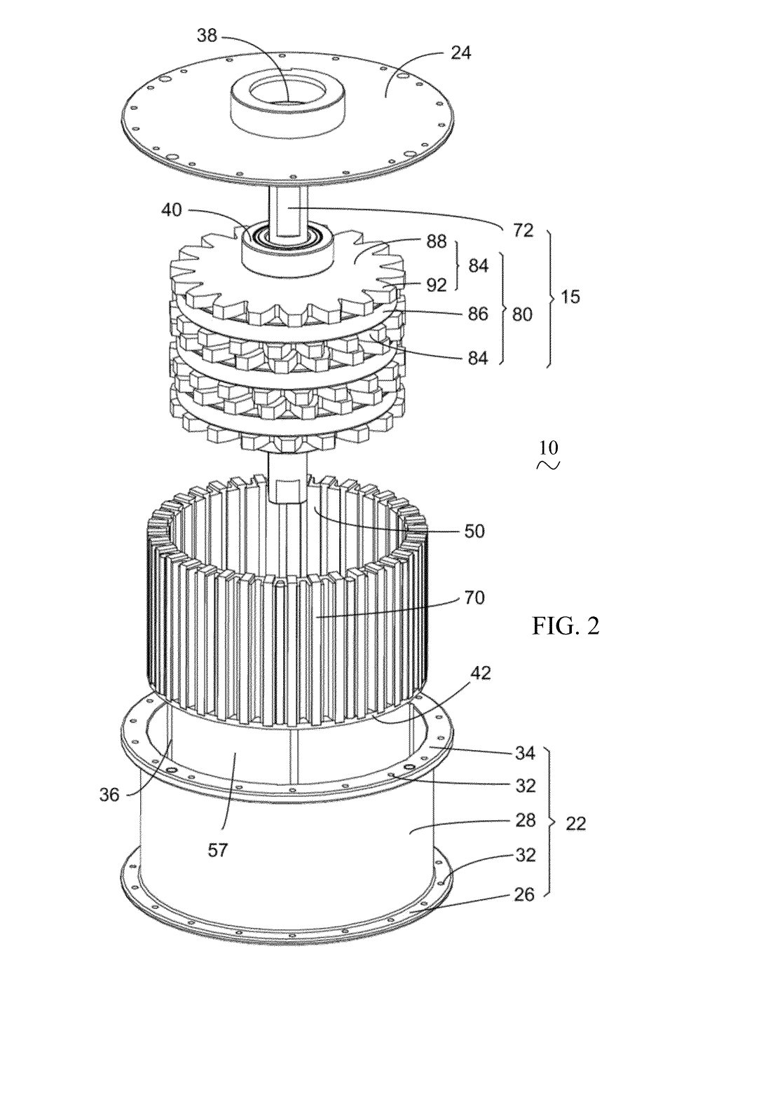

FIG. 2 illustrates an exploded view of motor 10 illustrated in FIG. 1. As illustrated in the figure, shell body 22 comprises a bottom surface 26 and a substantially cylindrical sidewall 28 extending perpendicularly to bottom surface 26 along an axial direction. A first shaft hole (not shown) may be located at the center of bottom surface 26.

In some embodiments, sidewall 28 is spaced away from an outer edge of bottom surface 26, so that a plurality of through holes 32 may be formed in bottom surface 26 between the outer edge thereof and sidewall 28. In some embodiments, a flange 34 extends outwards in a radial direction from a side of sidewalls 28 remote from bottom surface 26. Flange 34 may also contain a plurality of through holes 32, which may match the pattern of holes 32 on bottom surface 26. The through holes 32 on bottom surface 26 and flange 34 may be used in some embodiments to fix the motor 10 to an application, such as the spokes of a wheel of an electric bicycle. End cap 24 may be fixed to flange 34 through a plurality of fasteners. A second output shaft hole 38 may be located in the center of end cap 24, corresponding to the first output shaft hole on bottom surface 26.

In some embodiments, rotor 12 comprises a plurality of flux concentration strips 50 and a plurality of magnetic components 70. In accordance with a preferred embodiment, magnetic components 70 include permanent magnets. While the illustrated embodiments describe the magnetic components 70 as being permanent magnets, it will be understood that any component capable of generating a magnetic field may be used.

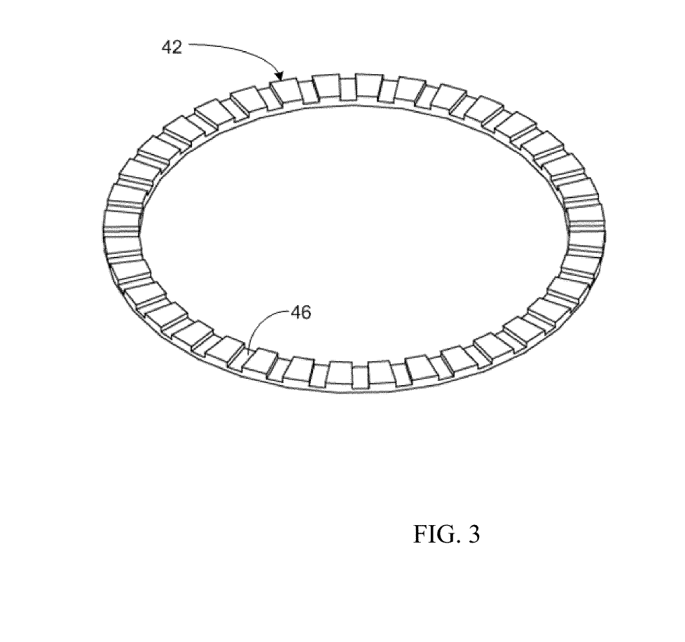

In some embodiments, rotor 12 also comprises a pair of fixed rings 42, e.g., a top fixed ring 42 attached to end cap 24 (not shown in FIG. 2), and a bottom fixed 42 ring attached to bottom surface 26. FIG. 3 illustrates fixed ring 42 used in motor 10 in accordance with some embodiments. Fixed ring 42 may be configured to be substantially annular, and to fit inside outer shell body 22. In the illustrated embodiment, a surface of fixed ring 42 comprises a plurality of channels or grooves 46. Grooves 46 may be circumferentially spaced in substantially equal intervals on a surface of fixed ring 42. The opposite surface of fixed ring 42 is attached to the inner surface of bottom plate 26 or end cap 24.

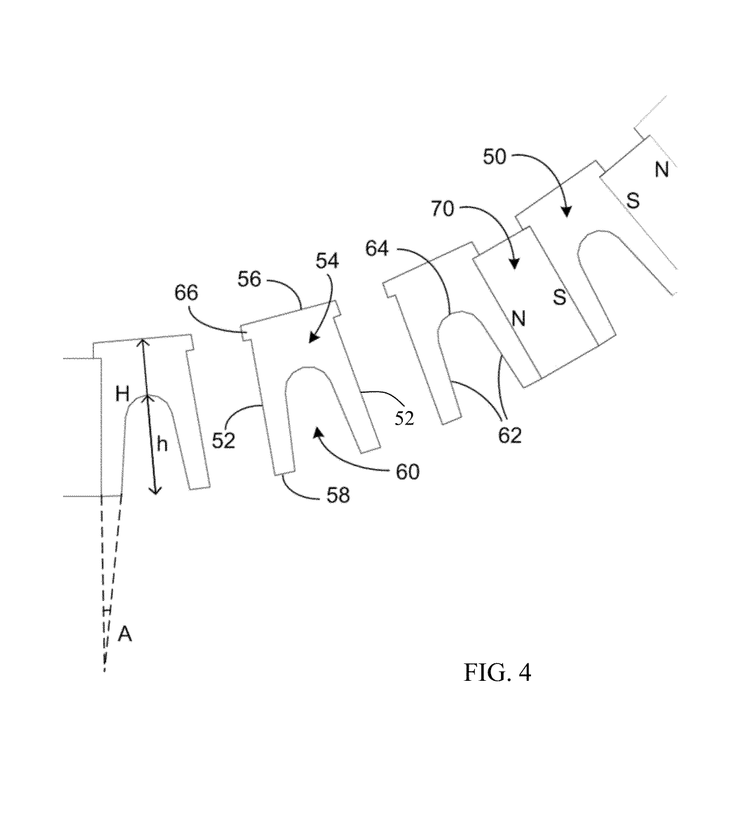

FIG. 4 illustrates a portion of rotor 12 in accordance with some embodiments. As illustrated in the figure, a flux concentration strip 50 comprises a pair of axially extending sidewalls 52, top and bottom end surfaces 54 substantially parallel to each other and connecting the pair of sidewalls 52, an outer surface 58, and an inner surface 56. Flux concentration strip 50 comprises a groove 60 formed in outer surface 58 running in the axial direction. Grooves 60 may be substantially “U” shaped, and be defined by two side surfaces 62 opposing the two sidewalls 52, and an arc surface 64 connecting two side surfaces 62.

Permanent magnets 70 may be substantially rectangular in shape. Permanent magnets 70 and flux concentration strips 50 are positioned in an alternating arrangement circumferentially, wherein each permanent magnet 70 is positioned between a pair of flux concentration strips 50, with the side surfaces of permanent magnet 70 abutting against sidewalls 52 of adjacent flux concentration strips 50. The outer surface of permanent magnets 70 may be configured to be substantially flush with outer surfaces 58 of the adjacent flux concentration strips 50. In some embodiments, the permanent magnets 70 are arranged having alternating polarities.

In some embodiments, permanent magnets 70 extend in the axial direction past end surfaces 54 of the flux concentration strips 50. For example, flux concentration strips 50 and permanent magnets 70 may form a substantially annular ring housed within shell body 22, wherein the portions of permanent magnets 70 that extend axially beyond end surfaces 54 are accommodated in grooves 46 of top and bottom fixing rings 42. This functions to hold the annular ring comprising permanent magnets 70 and flux concentration strips 50 in place, as well as reduce the axial length of motor 10.

In some embodiments, an inner surface 57 of sidewall 28 may comprise a plurality of flutes or protrusions 36 (hereinafter, flutes) extending inwards in the axial direction. Flutes 36 may be configured to interface with or fit within corresponding grooves 60 in concentration strips 50 on the annular ring, preventing the annular ring from rotating within shell body 22. Thus, flux concentration strips 50 and permanent magnets 70 are oriented axially along inner surface 57 of shell body 22, with the grooves 60 of flux concentration strips 50 facing inner surface 57.

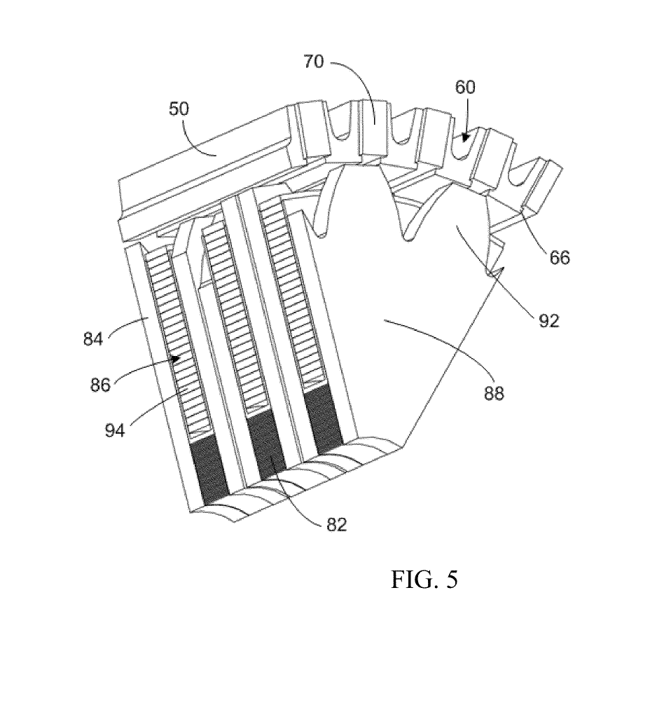

In some embodiments, stator 15 comprises a plurality of stator units 80 fixed to a central shaft 72, as illustrated in FIG. 2. A stator unit 80 comprises a stator yoke 82, a plurality of stator cores 84, and a plurality of wire loops 86 wound around stator yoke 82 and sandwiched between two adjacent stator cores 84, as illustrated in FIGS. 2 and 5.

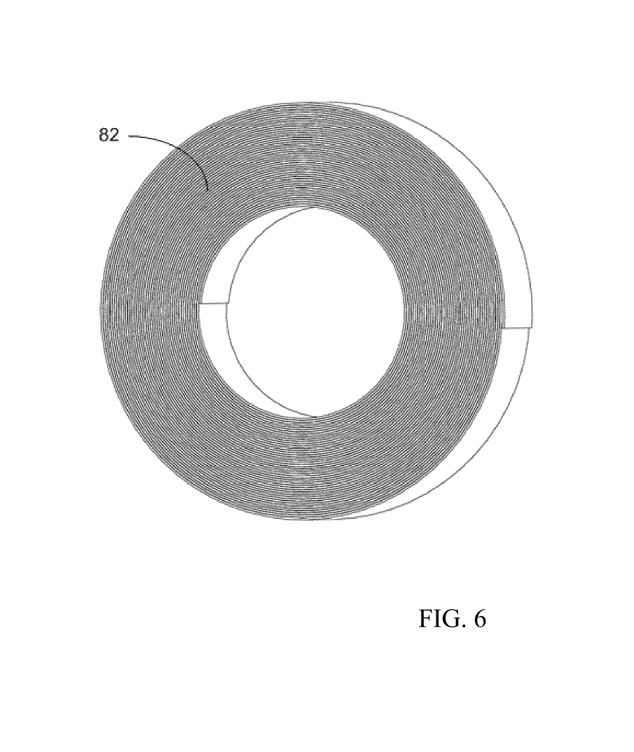

Stator yoke 82 may be configured to be substantially cylindrical or annular, and as illustrated in FIG. 6, and comprises one or more metal strips or pieces wrapped around central shaft 72. In some embodiments, the metal strips form a sleeve around central shaft 72. The metal strips of stator yoke 82 may have an insulating covering. For example, stator yoke 82 may be made of a strip of silicon steel with a thickness of between 0.2 millimeters (mm) and 0.35 mm, and having a covering of insulating paint.

Stator core 84 may be configured to be substantially gear-shaped, comprising a substantially cylindrical main body 88 and a plurality of uniformly spaced stator teeth 92 extending radially outwards from the outer edge of main body 88. The center of main body 88 may comprise a through hole, sleeve, or other structure (not shown) fixing main body 88 to central shaft 72. As is illustrated in FIG. 2, a stator unit 80 may comprise a pair of stator cores 84 fixed to central shaft 72and sandwiching stator yoke 82. Two stator cores 84 are arranged so that teeth 92 of different stator cores 84 are circumferentially offset from each other. In some embodiments, stator 15 may comprise one, two, three, or more stator units 80, configured such that stator teeth 92 of adjacent stator units 80 are circumferentially offset from each other. In accordance with the present invention, more stator units 80 in stator 15 is beneficial in increasing torque balance and reducing cogging.

FIG. 5 illustrates a cutaway portion of stator 15 in accordance with some embodiments. A coil loop 86 may be wrapped around the outside of stator yoke 82 and between two stator cores 84. Coil loop 86 may be wrapped directly around stator yoke 82, or may be placed over stator yoke 82 after being wound. Coil loop 86 may comprise a flat wire 94. In comparison with more traditional wires having a round cross-section, flat wire 94 may be used to increase the space usage efficiency of the area between stator cores 84, and increase the efficiency of motor 10.

Central shaft 72 of stator 15 passes through lower and upper through holes 38 in bottom surface 26 and end cap 24, respectively, of outer shell 20. In some embodiments, at least one bearing 40 may be mounted in lower and/or upper through holes 38, to provide support for central shaft 72 as it passes through bottom surface 26 and/or end cap 24. Thus stator 15 and rotor 12 are mechanically coupled to and able to rotate relative to each other.

During assembly, central shaft 72 may be fixed to the frame of an electric bicycle, and through holes 32 in bottom surface 26 and flange 34 of shell body 22 may be used to fix outer shell 20 to the spokes of a bicycle wheel. Consequently, as rotor 12 spins, the wheel of the electric bicycle will rotate and move the bicycle.

During operation, the flux generated by adjacent pairs of permanent magnets 70 travels through concentration strip 50 between sidewalls 52 and side surfaces 62, and is concentrated near inner surface 56. The flux passes through the gap between rotor 12 and stator 15 to stator teeth 92, and subsequently through main body 88 of stator core 84, through stator yoke 82, and to another stator core 84 on the axially opposite side of stator yoke 82. Through stator teeth 92 of the second stator core 84 (which are circumferentially offset from teeth 92 of the first stator core 84), the flux passes through the air gap between stator 12 and rotor 15, to reach an adjacent flux concentration strip 50. Because adjacent pairs of flux concentration strips 50 have opposite polarities, the flux thus travels through the intervening permanent magnet 70 between the two flux concentration strips 50 back to the original flux concentration strip 50, forming a closed magnetic loop. When a current runs through winding coils 86, a number of stator magnetic poles are created on each stator unit 80 corresponding to the rotor magnetic poles on rotor 12. In addition, a number of closed magnetic loops are created between the offset stator teeth 92. As such, rotation of motor 10 is created and maintained by the interactions between the magnetic poles of stator 15 and rotor 12.

In the illustrated embodiments, because flux concentration strips 50 contain grooves 60, the weight of flux concentration strips 50 is greatly reduced. In addition, permanent magnets 70 and sidewalls 52 of flux concentration strips 50 are flush with each other. The flux from permanent magnets 70 may pass through the area between sidewalls 52 of flux concentration strips 50 and side surfaces 62 of grooves 60 to be concentrated near inner wall 56, and the magnetic fields will not be substantially weakened by the presence of grooves 60.

During operation of motor 10, due to the changing direction of current, a vortex or eddy current flow may be generated in stator yoke 82 in a circumferential direction. Due to the insulating material between turns of the coil of the metal strip that comprises stator yoke 82, the eddy current is unable to form a closed annular loop compared to if the stator yoke 82 was made from a solid metal piece. Instead, the eddy current is forced to flow from one end of the metal strip, along the stator yoke coils, to the other end of the metal strip, and then back again (or vice versa). This has the effect of dividing the eddy current between flowing from a first end to a second of the metal strip, and from the second end to the first end. As a result, in comparison to a conventional stator yoke, the path of the eddy current is approximately doubled, while the conduction area is reduced by approximately half, resulting in stator yoke 82 with approximately four times the impedance of that of a conventional stator yoke. Thus, the amount of eddy current in stator yoke 82 may be greatly reduced.

In accordance with some embodiments, grooves 46 may be located directly in bottom surface 26 and end cap 24, thereby eliminating the need for fixing rings 42. Alternatively, flux concentration strips 50 and permanent magnets 70 may be fixed to shell body 22 (e.g., with an adhesive means), such that grooves 46 may no longer be necessary. It will be understood that in some embodiments, axial end surfaces of permanent magnets 70 may be configured to be substantially flush with the end surfaces 54 of flux concentration strips 50.

In some embodiments, flux concentration strips 50 may contain flanges 66 protruding from the inner side (closer to the stator 12) of sidewalls 52, as illustrated in FIG. 4, and configured such that the inner surfaces of permanent magnets 70 are flush with flanges 66.

In some embodiments as illustrated in FIG. 4, the ratio of the depth of a groove 60 (h) to the total length of a flux concentration strip 50 in the radial direction (H) may be configured to be between 45% and 75%, and preferably within the range of 55%-65%, in order to achieve a balance between of the flux concentration ability and the weight of flux concentration strip 50.

In some embodiments as illustrated in FIG. 4, sides 62 of grooves 60 may be oriented at an angle A relative to adjacent sidewall 52 of flux concentration strip 50. Angle A may be configured to be between 10° and 30°, in order to achieve a balance between of the flux concentration ability and the weight of the flux concentration strip 50.

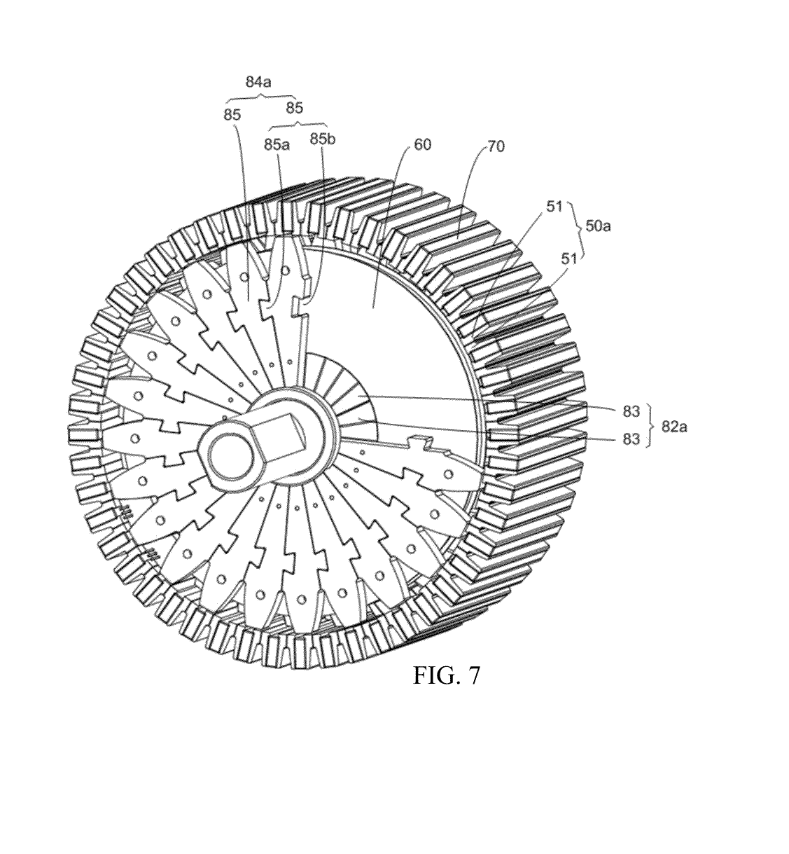

FIG. 7 illustrates an alternate embodiment of transverse flux motor 10. In the illustrated embodiment, flux concentration strips 50a, instead of being formed as a single component, may comprise a pair of symmetrical components 51. Such an arrangement may be used to allow for easier processing and manufacture of flux concentration strips 50a.

In addition, stator core 84a may comprise a plurality of core pieces 85 arranged circumferentially. The number of core pieces 85 used may correspond to the number of poles on stator 15 (e.g., number of stator teeth 92). For example, as illustrated in FIG. 7, each core piece 85 corresponds to one stator tooth 92. Core pieces 85 may contain structural features allowing adjacent core pieces 85 to be connected together. For example, each core piece 85 includes a protrusion 85a on one side, and a recess 85b on the other side configured to interface with or receive a protrusion 85a of an adjacent core piece 85. In some embodiments, each core piece 85 is elongate in shape, and comprises a first narrow end that interfaces with the first narrow end of an adjacent core piece 85, such that protrusion 85a is fitted inside recess 85b of the neighboring core piece 85. Also, a second narrow end opposite to the first narrow end of the core piece 85 is spaced away from the second narrow end of the adjacent core piece 85, and forms a stator tooth 92. In some embodiments, core pieces 85 are made from a plurality of silicon steel pieces stacked in the axial direction. Core pieces 85 may also comprise an insulating covering, which may function to reduce vortex or eddy currents during the operation of the motor. By having stator core 84a being comprised of multiple strip shaped core pieces 85, there is no need to create single large circles of silicon steel corresponding to the total area of stator core 84, potentially allowing for higher efficiency and more flexibility in material use.

In addition, in some embodiments as illustrated in FIG. 7, stator yoke 82a may comprise a plurality of yoke pieces 83 arranged circumferentially. Yoke pieces 83 may comprise metal with insulating material on the outside. Each yoke piece 83 may have a substantially fan-shaped cross section, with two side surfaces extending away from the axis of motor 10 connected by two substantially arcuate end surfaces. Adjacent yoke pieces 83 are configured to be flush with each other to form stator yoke 82a. The individual yoke pieces 83 split the stator yoke 82a into multiple pieces, weakening the vortex and eddy currents within the stator yoke 82a. It will be understood that the flux concentration strips 50a, stator core 84a, and stator yoke 82a may be used together in a single embodiment as illustrated in FIG. 7, or may be used independently from each other. For example, one embodiment may use stator cores 84a in combination with the flux concentration strips 50 and stator yoke 82 illustrated in FIG. 2.

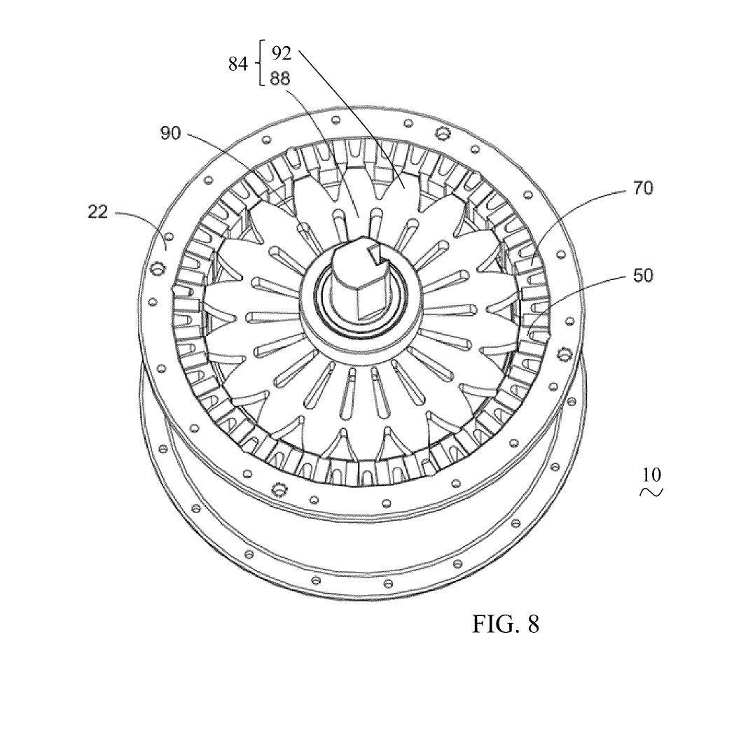

FIG. 8 illustrates a transverse flux motor 10 in accordance with an alternative embodiment. As illustrated in FIG. 8, a main body 88 of the stator cores 84 contains a plurality of through channels 90, which function to reduce the weights of stator cores 84 and motor 10. In some embodiments, through channels 90 may be arranged uniformly in the circumferential direction on the surface of main body 88, with the outer end of a channel 90 positioned near a base of a stator tooth 92.

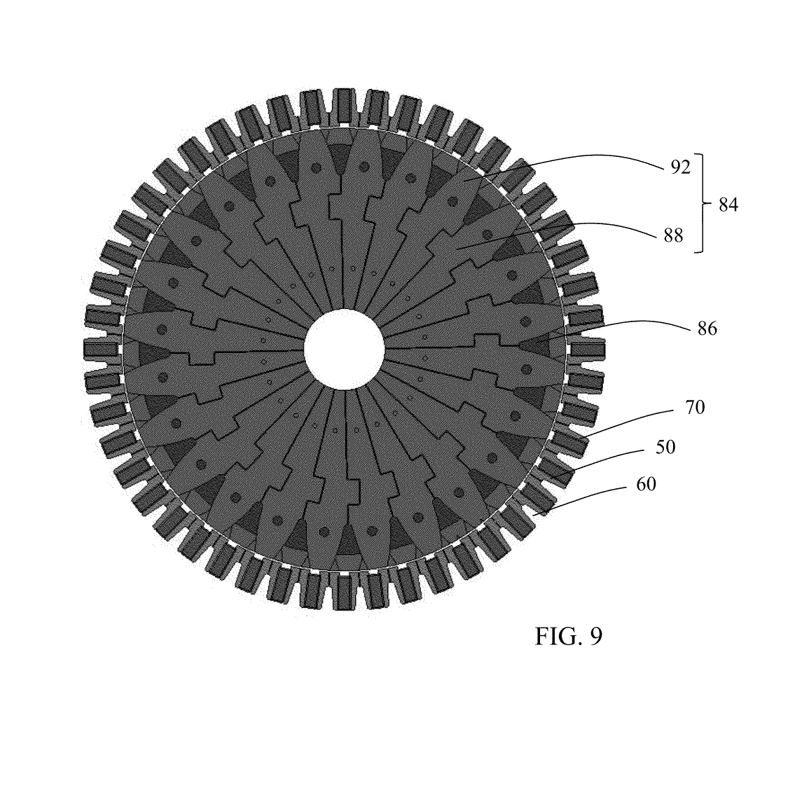

In some embodiments as illustrated in FIG. 9, the stator cores 84 are configured to have 24 stator teeth 92, and rotor 12 is configured to have 48 permanent magnets 70 and 48 flux concentration strips 50. A higher number of stator teeth 92 and flux concentration strips 50 results in a higher number of poles during operation. The increased number of poles allows for better performance at low speeds due to the reduction in cogging torque.

In the foregoing specification, various aspects have been described with reference to specific embodiments thereof. It will, however, be evident that various modifications and changes may be made thereto without departing from the broader spirit and scope of various embodiments described herein. For example, the above-described systems or modules are described with reference to particular arrangements of components. Nonetheless, the ordering of or spatial relations among many of the described components may be changed without affecting the scope or operation or effectiveness of various embodiments described herein. In addition, although particular features have been shown and described, it will be understood that they are not intended to limit the scope of the claims or the scope of other embodiments, and it will be clear to those skilled in the art that various changes and modifications may be made without departing from the scope of various embodiments described herein. The specification and drawings are, accordingly, to be regarded in an illustrative or explanatory rather than restrictive sense. The described embodiments are thus intended to cover alternatives, modifications, and equivalents.

1. A transverse flux electric motor, comprising:
a stator comprising at least one stator unit, wherein a stator unit comprises:
a first stator core comprising a plurality of stator teeth;
a second stator core axially offset from the first stator core and having a plurality of teeth circumferentially offset from the plurality of stator teeth of the first stator core; and
a stator yoke sandwiched between the first stator second stator cores; and
a rotor comprising a plurality of magnetic components and a plurality of flux concentration components arranged in an alternating pattern circumferentially, wherein a flux concentration component of the plurality of flux concentration components comprise a groove on a surface remote from the stator.

2. The transverse flux electric motor of claim 1, wherein the rotor is configured to spin outside the stator.

3. The transverse flux electric motor of claim 1, further comprising at least one winding coil wrapped around the stator yoke.

4. The transverse flux electric motor of claim 3, wherein the at least one winding coil comprises a flat wire.

5. The transverse flux electric motor of claim 1, wherein the plurality of magnetic components comprise a plurality of permanent magnets arranged with alternating polarities.

6. The transverse flux electric motor of claim 1, wherein the first stator core comprise a plurality of circumferentially arranged core pieces.

7. The transverse flux electric motor of claim 6, wherein a core piece of the plurality of core pieces comprises structural features configured to interface with adjacent core pieces.

8. The transverse flux electric motor of claim 1, wherein the stator yoke comprises a coiled metal strip with an insulating covering.

9. The transverse flux electric motor of claim 8, wherein the metal strip has a thickness between 0.2 millimeter (mm) and 0.35 mm.

10. The transverse flux electric motor of claim 1, wherein the stator yoke comprises a plurality of stator yoke pieces arranged circumferentially.

11. The transverse flux electric motor of claim 10, wherein a stator yoke of the plurality of stator yoke pieces has an insulating covering.

12. The transverse flux electric motor of claim 1, wherein the first stator core comprises a plurality of circumferentially arranged through channels.

13. The transverse flux electric motor of claim 2, wherein the rotor further comprises a substantially cylindrical outer shell.

14. The transverse flux electric motor of claim 13, wherein the outer shell is configured to be mounted to the spokes of an electric bicycle wheel.

15. The transverse flux electric motor of claim 13, wherein an inner surface of the outer shell comprises one or more protrusions interfacing with the groove on the flux concentration component.

16. The transverse flux electric motor of claim 5, wherein a permanent magnet of the plurality of permanent magnets is axially longer than a flux concentration component of the plurality of flux concentration components.

17. The transverse flux electric motor of claim 1, wherein a depth of the groove in the flux concentration component is configured to be between 45% and 75% of a radial width of the flux concentration component.

18. The transverse flux electric motor of claim 1, wherein the plurality of flux concentration component comprises two sidewalls contacting adjacent magnetic components and two side surfaces at opposite sides of the groove, the sidewall and the adjacent side surface have an angle configured to be between 10 degrees and 30 degrees.

19. The transverse flux electric motor of claim 1, wherein the rotor comprises 48 magnetic components.

20. The transverse flux electric motor of claim 1, wherein the stator comprises three stator units.
